(19) United States
(12) Patent Application Publication
(10) Pub. No.: US 2025/0208661 A1
(43) Pub. Date: Jun. 26, 2025

(54) ELECTRONIC DEVICE

(71) Applicant: Lenovo (Beijing) Limited, Beijing (CN)

(72) Inventors: Kun CHEN, Beijing (CN); Sai GAO, Beijing (CN)

(21) Appl. No.: 18/981,424

(22) Filed: Dec. 13, 2024

(30) Foreign Application Priority Data
Dec. 22, 2023 (CN) 202311787751.8

(51) Int. Cl. G06F 1/16

(52) U.S. Cl. CPC G06F 1/1656; G06F 1/1616; G06F 1/1652

(57) ABSTRACT

This application provides an electronic device, and a method applied on the electronic device. The electronic device includes a first body, a second body and a third body. The first connecting assembly has a first state and a second state different from the first state. The third body is connected to the second body through a second connecting assembly. The electronic device includes a display screen, connected to both the second body and the third body. The display screen and the input surface are positioned on the same side of the electronic device. If the electronic device is in a first operating mode, the relative position between the first body and the second body remains unchanged; if the electronic device is in a second operating mode, the relative position between the second body and the third body remains unchanged.

### CROSS-REFERENCE TO RELATED APPLICATION

This application claims priority to Chinese Patent Application No. 202311787751.8, filed on Dec. 22, 2023, and the entire content of which is incorporated herein by reference.

### TECHNICAL FIELD

The present disclosure relates to the field of electronic device technology, and more particularly to an electronic device.

### BACKGROUND

With electronic devices, users need to repeatedly make adjustments between different forms of the device to achieve the desired use form. This makes the use process more complicated for the user, which leads to unsatisfied user experience.

### SUMMARY

One aspect of the present disclosure provides an electronic device. The electronic device includes: a first body, including an input surface; a second body, connected to the first body through a first connecting assembly, wherein the first connecting assembly has a first state and a second state different from the first state; a third body, connected to the second body through a second connecting assembly, wherein the second connecting assembly has a first state, and a second state different from the first state; and a display screen, connected to both the second body and the third body, wherein the display screen and the input surface are positioned on a same side of the electronic device. If the electronic device is in a first operating mode, the first connecting assembly is in the second state, such that the relative position between the first body and the second body remains unchanged, and the second connecting assembly is in the first state. If the electronic device is in a second operating mode, the first connecting assembly is in the first state and the second connecting assembly is in the second state, such that the relative position between the second body and the third body remains unchanged.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a schematic structural diagram of the electronic device according to an embodiment of the present disclosure;

FIG. 2 is a schematic structural diagram of the electronic device according to another embodiment of the present disclosure;

FIG. 3 is a schematic structural diagram of the electronic device according to another embodiment of the present disclosure;

FIG. 4 is a schematic structural diagram of the electronic according to another embodiment of the present disclosure;

FIG. 5 is an enlarged view of part A in FIG. 4;

FIG. 6 is a schematic structural diagram of the electronic according to another posture as shown in FIG. 4;

FIG. 7 is an enlarged view of part B in FIG. 6;

FIG. 8 is a schematic structural diagram of the electronic device according to another embodiment of the present disclosure;

FIG. 9 is an enlarged view of part C in FIG. 8;

FIG. 10 is a schematic structural diagram of the electronic device according to another posture as shown in FIG. 8;

FIG. 11 is an enlarged view of part D in FIG. 10.

### DESCRIPTION OF REFERENCE NUMBERS IN THE DRAWINGS

10—First body; 11—Input surface; 20—Second body; 21—First connecting assembly; 211—Limiting slot; 30—Third body; 31—Second connecting assembly; 311—Protrusion; 40—Display screen; 41—First region; 42—Second region; 43—Third region; 50—Adjustment assembly; 51—Linkage; 52—Elastic component; 53—Transmission wheel; 54—Transmission component; 60—Supporting part.

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings.

It should be understood that various modifications can be made to the embodiments in the present disclosure. Therefore, the following description should not be considered restrictive, but merely as examples of the embodiments. Those skilled in the art will envision other modifications within the scope of the present disclosure.

The drawings included in the specification and forming a part thereof illustrate embodiments of the present disclosure and, together with the general description provided above and the detailed description of the embodiments given below, serve to explain the principles of the present disclosure.

The following description of preferred embodiments, provided as non-limiting examples, with reference to the accompanying drawings, will make these and other features of the present application more apparent.

It should also be understood that, although the present disclosure has been described with reference to some specific examples, many other equivalent forms of the present disclosure can be determined by those skilled in the art, which have the characteristics described in the claims and are thus within the scope defined thereby.

When considered with the drawings, in view of the following detailed description, the aspects, features, and advantages of the present disclosure will become apparent.

Specific embodiments of the present disclosure will be described hereinafter with reference to the drawings; however, it should be understood that the disclosed embodiments are merely examples of the present disclosure and may be implemented in various ways. Well-known and/or repetitive functions and structures are not described in detail to avoid unnecessary or redundant details that could obscure the present disclosure. Therefore, the specific structural and functional details disclosed herein are not intended to limit the present disclosure but merely serve as a basis for the claims and a representative foundation for teaching those skilled in the art to utilize the present disclosure with virtually any suitable detailed structure in various ways.

The specification may use phrases such as “in one embodiment,” “in another embodiment,” “in yet another embodiment,” or “in other embodiments,” which may refer to the same or different embodiments of the present disclosure.

The embodiments of the present disclosure are described below in detail with the accompanying drawings.

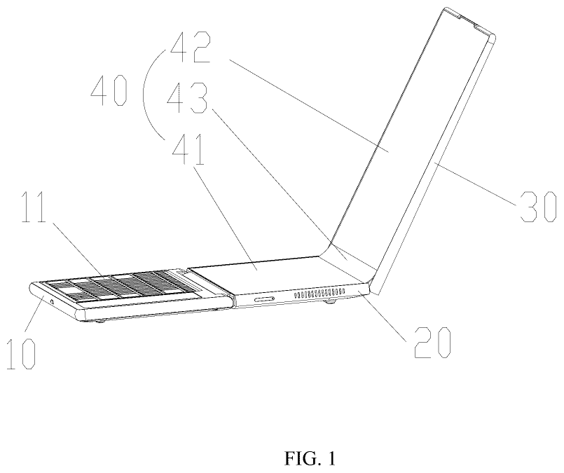

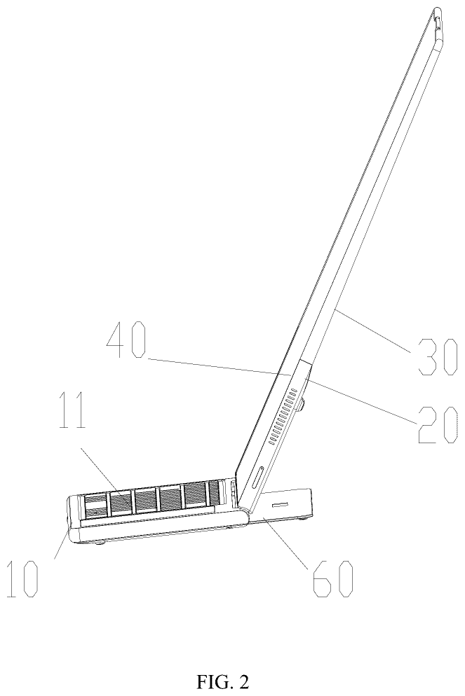

As shown in FIG. 1 to FIG. 3, the present disclosure provides an electronic device, comprising:

A first body 10, including an input surface 11;

A second body 20, connected to the first body 10 through a first connecting assembly 21, wherein the first connecting assembly 21 has a first state and a second state different from the first state;

A third body 30, connected to the second body 20 via a second connecting assembly 31, wherein the second connecting assembly 31 has a first state and a second state different from the first state;

A display screen 40, connected to both the second body 20 and the third body 30, wherein the display screen 40 and the input surface 11 are located on the same side of the electronic device.

In some embodiments, if the electronic device is in a first operating mode, the first connecting assembly 21 is in the second state, which keeps the relative position between the first body 10 and the second body 20 unchanged, and the second connecting assembly 31 is in the first state.

If the electronic device is in a second operating mode, the first connecting assembly 21 is in the first state, and the second connecting assembly 31 is in the second state, which keeps the relative position between the second body 20 and the third body 30 unchanged.

In this embodiment, the structure of the first body 10 are plate-shaped. One surface of the first body 10 is be equipped with an input component, which may form an input area, to create the input surface 11. The input surface 11 can receive user input operations. In some embodiments, the input component can be a keyboard or touchpad, configured on the first body 10, to form the input surface 11. Input operations from user can be performed via the keyboard and/or touchpad. In some embodiments, the first body 10 may have a base structure or be equipped with supporting pads for placement on surfaces like a desktop.

The structures of the second body 20 and the third body 30 are also generally plate shaped. The opposite sides of the second body 20 are respectively connected to the first body 10 through the first connecting assembly 21, and to the third body 30 through the second connecting assembly 31, which allows rotational connections. The second body 20 can flip relative to the first body 10 through the first connecting assembly 21, and the third body 30 can flip relative to the second body 20 through the second connecting assembly 31. Both the first body 10 and the second body 20 are connected to the display screen 40 of the electronic device. The display screen 40 and the input surface 11 are positioned on the same side of the electronic device. This allows the user to directly view the content displayed on the display screen 40 while performing input operations, which also further helps associated input actions.

In this embodiment, to adjust the relative positional relationship between the first body 10, the second body 20, and the third body 30, the first connecting assembly 21 and the second connecting assembly 31 each have two different states, which are a first state and a second state. The second state refers to an inactive state of the first connecting assembly 21 and the second connecting assembly 31, while the first state refers to an active state of the first connecting assembly 21 and the second connecting assembly 31. For example, when the first connecting assembly 21 is a first rotating shaft, the second body 20 can flip relative to the first body 10 through the rotational action of the first rotating shaft. When the first rotating shaft is locked by motor control or engaged with other components to prevent rotation, it is in the inactive second state, and the relative positional relationship between the first body 10 and the second body 20 is fixed, prohibiting further rotation. It can be understood that, when the first rotating shaft is not locked or not interfered with by other components, it remains in the active first state, which allows the first rotating shaft to rotate based on user needs. This enables the user to adjust the relative positional relationship between the first body 10 and the second body 20 by rotating the shaft. Similarly, the second connecting assembly 31 can be a second rotating shaft, with its states corresponding to those of the first rotating shaft, so further similar explanation is omitted here.

In some embodiments, the different states of the first connecting assembly 21 and the second connecting assembly 31 can be controlled and switched via a motor, or through methods such as clamping or locking mechanically.

In some embodiments of the present disclosure, when the first connecting assembly 21 is in the second state, which is in an inactive state, and more specifically locked, the first body 10 and the second body 20, connected by the first connecting assembly 21, maintain their current relative positional relationship, and are prevented from any movement through the first connecting assembly 21 to change the relative positional relationship (locked). Alternatively, when in the first state, the first connecting assembly 21 is in an active state, which allows the first body 10 and the second body 20 connected by the first connecting assembly 21 to flip through its rotational action. As a result, the relative positional relationship between the first body 10 and the second body 20 can be changed by the rotation of the first connecting assembly 21.

In some embodiments, the first connecting assembly 21 can be a first rotating shaft. When the first rotating shaft is in the inactive second state, for example, in a locked state due to interference, it cannot rotate or function, and the relative position between the first body 10 and the second body 20 remains fixed and cannot be changed. When the first rotating shaft is in the active first state, for example, in a rotatable state, the first body 10 can flip relative to the second body 20 through the rotational action of the first rotating shaft, which changes the relative positional relationship between the first body 10 and the second body 20.

In some embodiments of the present disclosure, when the second connecting assembly 31 is in the second state, it is in an inactive state, and the second body 20 and the third body 30, which are connected by the second connecting assembly 31, maintain their current relative positional relationship, and are prevented from any movement by the second connecting assembly 31 to change the relative positional relationship (locked). Alternatively, when in the first state, the second connecting assembly 31 is in an active state, for example, in a rotatable state. In some embodiments, the second body 20 and the third body 30 connected by the second connecting assembly 31 can flip through the rotational action of the second connecting assembly 31, which changes the relative positional relationship between the second body 20 and the third body 30.

In some embodiments, the second connecting assembly 31 can be a second rotating shaft. When the second rotating shaft is in the inactive second state, for example, it may be in an unlocked state, but the damping force of the second rotating shaft is greater than the damping force of the first rotating shaft, in some embodiments, a force applied to the third body 30 will preferentially make the first rotating shaft rotate, which leads to the second rotating shaft being in the inactive second state and being unable to be rotated by the force from the user. This fixes the relative position between the second body 20 and the third body 30. When the second rotating shaft is in the active first state, for example, in a rotatable state, and the first rotating shaft is in the inactive second state, the force applied to the third body 30 can make the second rotating shaft rotate, which allows the third body 30 to flip relative to the second body 20. This changes the relative positional relationship between the second body 20 and the third body 30.

Therefore, in this embodiment, the state of the first connecting assembly 21 is different from the state of the second connecting assembly 31, and when the state of the first connecting assembly 21 changes, the state of the second connecting assembly 31 can also change correspondingly. Similarly, when the state of the second connecting assembly 31 changes, the state of the first connecting assembly 21 will also change accordingly. As a result, the electronic device in this embodiment can achieve different operating modes based on the different states of the first connecting assembly 21 and the second connecting assembly 31. In some embodiments, when the electronic device is in the first operating mode, the first connecting assembly 21 is in the inactive second state, and it is impossible to move the first body 10 and the second body 20 through the first connecting assembly 21. This keeps the relative positional relationship between the first body 10 and the second body 20 unchanged. In some embodiments, the second connecting assembly 31 is in the active first state, which allows the adjustment of electronic device by the second connecting assembly 31. This makes the relative positional relationship between the second body 20 and the third body 30 changeable.

In some embodiments of the present disclosure, when the electronic device is in the second operating mode, the first connecting assembly 21 is in the active first state, which allows relative movement between the first body 10 and the second body 20, through the action of the first connecting assembly 21. This enables the relative positional relationship between the first body 10 and the second body 20 to be changed through the first connecting assembly 21. In some embodiments, the second connecting assembly 31 is in the inactive second state, which prevents any movement between the second body 20 and the third body 30 through the action of the second connecting assembly 31. This ensures the relative positional relationship between the first body 10 and the second body 20 stays unchanged.

In this embodiment of the present disclosure, the first body 10 can be the main unit of the electronic device. The areas of the display screen 40 corresponding to the second body 20 and the third body 30 can be a first region 41 and a second region 42 of the electronic device, respectively. In other embodiments, the display screen 40 of the electronic device may include a flexible screen part. The areas of the display screen 40 corresponding to the second body 20 and the third body 30 can be the first region 41 and the second region 42 of the electronic device, respectively. The connecting area between the first region 41 and the second region 42 can be a flexible screen part which is capable of bending.

Therefore, the main unit of the electronic device is connected to the first body 10 through the first connecting assembly 21, and the first body 10 is connected to the third body 30 through the second connecting assembly 31. When the relative positional relationship between the second body 20 and the third body 30 is changing, either the bending angle between the first region 41 and the second region 42, or the degree of curvature in the flexible screen portion can be modified.

Therefore, when the electronic device is in the first operating mode, the first connecting assembly 21 is in the inactive second state, which prevents any movement between the main unit and the first body 10 through the action of the first connecting assembly 21. As a result, the relative positional relationship between the main unit and the first region 41 remains unchanged. At the same time, the second connecting assembly 31 is in the active first state, which allows the electronic device to be adjusted through the action of the second connecting assembly 31. As a result, the relative positional relationship between the first body 10 and the second body 20 can change, which also allows the bending angle between the first region 41 and the second region 42 to change accordingly.

Alternatively, when the electronic device is in the second operating mode, the first connecting assembly 21 is in the active first state, which allows relative movement between the main unit and the first body 10 through the action of the first connecting assembly 21. This also lets the relative positional relationship between the main unit and the first region 41 change. At the same time, the second connecting assembly 31 is in the inactive second state, which prevents any movement between the first body 10 and the second body 20 through the action of the second connecting assembly 31. As a result, the bending angle between the first region 41 and the second region 42 remains unchanged, which also maintains the current bent or flat state of the display screen 40. In some embodiments, the display screen 40, in its bent or flat state, can flip as a whole relative to the main unit.

Moreover, in some embodiments of the present disclosure, when the electronic device is in the first operating mode, the first connecting assembly 21 is in the inactive second state, and the second connecting assembly 31 is in the active first state. In some embodiments, any relative movement between the first body 10 and the second body 20 connected by the first connecting assembly 21 is prevented, which keeps their relative positional relationship unchanged, while relative movement can be enabled between the second body 20 and the third body 30, connected by the second connecting assembly 31, which allows flipping, and changes the angle between them. At this point, in order to switch the operating mode of the electronic device, the third body 30 can be controlled to continue moving through the action of the second connecting assembly 31, until the third body 30 reaches a first relative positional relationship with the second body 20.

In some embodiments, the first relative positional relationship can be a state that the third body 30 forms a 180-degree angle with respect to the second body 20, and the display screen 40, which is connected to both the second body 20 and the third body 30, is fully flattened, presenting a smooth and flat state.

In this embodiment, when the third body 30 moves to form a 180-degree angle with the second body 20, the first connecting assembly 21 can switch from the inactive second state to the active first state, and the second connecting assembly 31 will switch from the active first state to the inactive second state. As a result, the electronic device switches from the first operating mode to the second operating mode. After switching modes, any relative movement is prevented between the second body 20 and the third body 30, connected by the second connecting assembly 31, while relative movement can occur between the first body 10 and the second body 20, connected by the first connecting assembly 21, which allows the angle between them to change. In some embodiments, the second body 20 and the third body 30 maintain the 180-degree angle and function as a single entire unit, capable of moving relative to the first body 10 through the action of the first connecting assembly 21.

In some embodiments of the present disclosure, when the first body 10 is the main unit of the electronic device, and the areas of the display screen 40 corresponding to the second body 20 and the third body 30 are the first region 41 and the second region 42 of the electronic device, respectively, in the first operating mode of the electronic device, the main unit is connected to the first region 41 through the first rotating shaft in the inactive state, which stops any relative movement and maintains their current relative positional relationship. The second region 42 can move relative to the first region 41 through the rotational action of the second rotating shaft. For instance, in the first operating mode, the main unit and the first region 41 can keep a 180-degree angle, wherein both of them are placed on a desktop, and maintain the relative positional relationship. The second region 42 can move relative to the first region 41 through the action of the second rotating shaft, which allows adjustment of the angle from the second region 42 to the first region 41 and the main unit. Obviously, the angle between the main unit and the first region 41 can be any other degrees, and the specific value of the angle can be adjusted according to the user's needs. This embodiment is just provided as an example and such an aspect shall not be limited.

When switching the operating mode, the second region 42 is controlled to move to a first relative positional relationship with the first region 41, forming a 180-degree angle. At this point, the first rotating shaft switches from the inactive second state to a rotatable first state, and the second rotating shaft switches from the rotatable first state to the inactive second state. In some embodiments, with the switched mode, the display screen 40 corresponding to the first region 41 and the second region 42 remains in a fully flattened state. The display screen 40 can then move relative to the main unit through the rotational action of the first rotating shaft, which allows adjustment of the angle between the display screen 40 and the main unit.

In some embodiments, when only the first body 10 of the electronic device is placed on a supporting surface such as a desktop, while the second body 20 and the third body 30 are away from the desk surface, to ensure the stability of the electronic device, the weight of the first body 10 can be adaptively increased. This additional weight can match the required weight to support the second body 20 and the third body 30, which prevents the device from tipping over.

In other embodiments, to avoid making the electronic device too heavy, a supporting part 60 can be configured to support the second body 20 and the third body 30. One end of the supporting part 60 is connected to the first body 10 or the second body 20, and at least the other end abuts against the supporting surface, which provides the necessary support.

In some embodiments of the present disclosure, the supporting part 60 can be a fixedly connected flat plate extending from the first body 10 in the direction toward the first connecting assembly 21. In some embodiments, one end of the flat plate is connected to the first body 10, and the bottom surface and the other end of the flat plate abut against the supporting surface. The orthogonal projection of the second body 20 onto the desktop overlaps at least partially with the flat plate, which provides the necessary support for the second body 20 and the third body 30. Alternatively, the flat plate can also be integrally formed by extending the housing portion of the first body 10. In some embodiments, the portion of the housing of the first body 10 extending beyond the first connecting assembly 21 forms the supporting part 60.

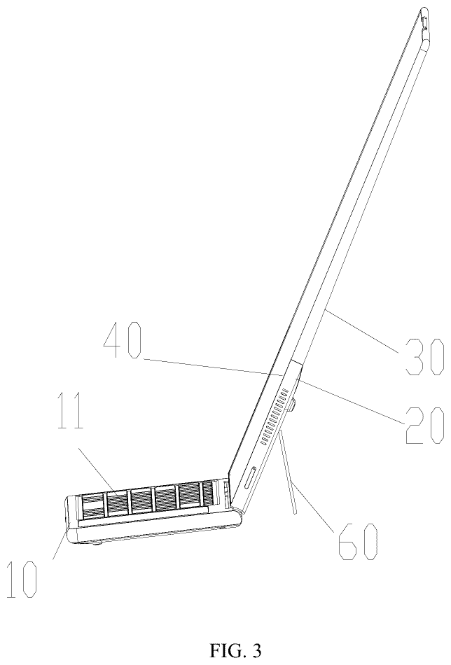

In some embodiments of the present disclosure, the supporting part 60 can also be formed by a movable bracket set on the housing of the second body 20 (as shown in FIG. 3). The movable bracket is rotatably connected to the middle or upper part of the housing in the second body 20. When the second body 20 is placed on a supporting surface, the movable bracket can be stored in a receiving space formed in the housing of the second body 20. When the second body 20 is lifted off the desktop, the movable bracket can rotate relative to the second body 20 to extend from its receiving space and provide support on the desktop, which prevents the electronic device from tipping over.

In some embodiments of the present disclosure, when the electronic device is in the second operating mode, the first connecting assembly 21 is in the active first state, and the second connecting assembly 31 is in the inactive second state. In some embodiments, any relative movement is prevented between the between the second body 20 and the third body 30, connected by the second connecting assembly 31, which keeps their relative positional relationship unchanged, while the first body 10 and the second body 20, connected by the first connecting assembly 21, is able to flip relative to each other. At this point, in order to switch the operating mode of the electronic device, the second body 20 can be controlled to continue moving through the action of the first connecting assembly 21, until the second body 20 reaches a second relative positional relationship with the first body 10.

In some embodiments, the second relative positional relationship can be a state that when the first body 10 and the second body 20 form a 180-degree angle, both the first body 10 and the second body 20 can come into contact with the same supporting surface. For instance, when the first body 10 is placed on a desk, the second body 20 can also touch the surface of the desk. Obviously, in some embodiments, the bottoms of the first body 10 and the second body 20 can be equipped with supporting pads, which provide respective support and helping heat dissipation.

In this embodiment, when the second body 20 moves to form a 180-degree angle relative to the first body 10, the second connecting assembly 31 can switch from the inactive second state to the active first state, and the first connecting assembly 21 switches from the active first state to the inactive second state. In some embodiments, the electronic device switches from the second operating mode to the first operating mode. In the switched operating mode, any relative movement is prevented between the first body 10 and the second body 20, connected by the first connecting assembly 21, while relative movement is enabled between the second body 20 and the third body 30, connected by the second connecting assembly 31, which allows the angle between them to be adjustable. In some embodiments, the first body 10 and the second body 20 maintain a 180-degree angle and be placed as an entire unit on the supporting surface, while the third body 30 is able move relative to the first body 10 and the second body 20 through the action of the second connecting assembly 31.

In some embodiments of the present disclosure, when the first body 10 is the main unit of the electronic device, and the areas of the display screen 40 corresponding to the second body 20 and the third body 30 are the first region 41 and the second region 42 of the electronic device, respectively. In the second operating mode, the first region 41 and the second region 42 are connected by the second rotating shaft, which is in the inactive state, and which maintains their relative positional relationship. The main unit and the first region 41 can move through the rotational action of the first rotating shaft.

When switching the operating mode, the first region 41 is controlled to move to a second relative positional relationship, where it forms a 180-degree angle with the main unit. At this point, the second rotating shaft switches from the inactive second state to the rotatable first state, and the first rotating shaft switches from the rotatable first state to the inactive second state. In some embodiments, with the switched mode, the first rotating shaft is in the inactive state, which makes the main unit and the first region 41 remain flat and unchanged, while the second region 42 can rotate relative to the first region 41 and the main unit, through the rotational action of the second rotating shaft, which allows the angle of the part of the display screen 40 corresponding to the first region 41 relative to the main unit adjustable.

It can be understood that the electronic device of the present disclosure can switch operating modes during actual use through the coordinated operation of a motor and a sensor.

In some embodiments of the present disclosure, in an initial state, the electronic device is in the first operating mode, and the current posture is the closed state, where both the first body 10 and the second body 20 are in contact with the supporting surface, and the third body 30 is folded over the first body 10 and the second body 20. In this state, the first connecting assembly 21 is in the inactive second state, and the second connecting assembly 31 is in the active first state. The user can apply force to the third body 30, which allows the third body 30 to move continuously through the action of the second connecting assembly 31 until the third body 30 is in a flattened state relative to the second body 20. At this point, when the sensor detects that the first body 10, second body 20, and third body 30 are in a flattened state, the motor can be used to control the first connecting assembly 21 to switch from the inactive second state to the active first state. Correspondingly, the second connecting assembly 31 will switch from the active first state to the inactive second state. This allows the electronic device to switch from the first operating mode to the second operating mode. At this point, the electronic device is in a posture that, the first body 10, second body 20, and third body 30 are all in contact with the supporting surface, forming a flattened state.

When the electronic device is in the second operating mode, and the electronic device is in a posture that the first body 10, second body 20, and third body 30 are all flattened together, the user can apply force by lifting the third body 30. In some embodiments, the second body 20 and the third body 30, connected by the second connecting assembly 31, remain in the flattened state and move as an entire unit relative to the first body 10 through the action of the first connecting assembly 21. At this point, the display screen 40 remains in a flattened state, and the angle between it and the first body 10 can be adjusted.

Moreover, when the electronic device is in the second operating mode, and the user adjusts the second body 20 and the first body 10 to be in a flattened state again, since the second body 20 and the third body 30 already remain in a flattened state, the first body 10, second body 20, and third body 30 then form a flattened state again. At this point, when the sensor detects that the first body 10, second body 20, and third body 30 are in the flattened state again, the motor can be used to control the first connecting assembly 21 to switch from the active first state to the inactive second state. Correspondingly, the second connecting assembly 31 switches from the inactive second state to the active first state, which allows the electronic device to switch from the second operating mode to the first operating mode. At this point, the electronic device is in a posture that the first body 10, second body 20, and third body 30 are all in contact with the supporting surface, which forms a flattened state.

When the electronic device is in the first operating mode, and the posture is such that the first body 10, second body 20, and third body 30 form a flattened state, the user can apply force by lifting the third body 30. At this point, the first body 10 and the second body 20, connected by the first connecting assembly 21, remain in the flattened state and in contact with the supporting surface as an entire unit. The third body 30 can move relative to the first body 10 and the second body 20, through the action of the second connecting assembly 31, which allows the angle between the third body 30 and the first body 10 and second body 20 to be adjustable.

Moreover, when the electronic device is in the first operating mode and the user adjusts the third body 30 and the second body 20 to be in the flattened state again, since the first body 10 and the second body 20 already remain in the flattened state, the first body 10, second body 20, and third body 30 forms the flattened state again. At this point, when the sensor detects that the first body 10, second body 20, and third body 30 are in the flattened state again, the motor can be used to control the first connecting assembly 21 to switch from the inactive second state to the active first state. Correspondingly, the second connecting assembly 31 switches from the active first state to the inactive second state, which allows the electronic device to switch from the first operating mode to the second operating mode. At this point, the electronic device is in a posture that the first body 10, second body 20, and third body 30 are all in contact with the supporting surface, which forms the flattened state.

In some embodiments, when the first body 10, second body 20, and third body 30 of the electronic device in the present disclosure are adjusted to form the flattened state during the posture adjustment, the operating mode can be switched through the configuration of the motor and sensor.

In some embodiments of the present disclosure, when the electronic device is in the second operating mode, the first connecting assembly 21 is in the active first state, and the second connecting assembly 31 is in the inactive second state. In some embodiments, any relative movement is prevented between the second body 20 and the third body 30, connected by the second connecting assembly 31, which keeps their relative positional relationship unchanged, while the first body 10 and the second body 20, connected by the first connecting assembly 21, is able to move relative to each other and flip. At this point, the friction of the second connecting assembly 31 in the inactive state is relatively high, and if the force applied by the user is less than this friction, it is unable to move the second connecting assembly 31, which means that the relative positional relationship between the second body 20 and the third body 30 cannot be adjusted.

In some embodiments, in order to flip the third body 30 of the electronic device, in this embodiment, the user needs to apply a pushing force on the third body 30 toward the first body 10. If the force transmitted to the second connecting assembly 31 is greater than the friction of the second connecting assembly 31 in the inactive state, the second connecting assembly 31 starts to move. At this point, the second connecting assembly 31 switches to the active first state, and under the pushing force, the third body 30 moves closer to the second body 20 until it is folded against the second body 20. In this third relative positional relationship, the angle between the third body 30 and the second body 20 is 0 degree. In some embodiments, the part of display screen 40 corresponding to the third body 30 folds against the part of display screen 40 corresponding to the second body 20.

In some embodiments of this embodiment, the size of the flattened plate-like structure formed by the first body 10 and the second body 20 can match the size of the third body 30. This allows the third body 30 to fold onto the second body 20 and cover the entire area formed by the first body 10 and the second body 20.

In some embodiments of the present disclosure, the first connecting assembly 21 provides a first force for the second body 20 relative to the first body 10, and the second connecting assembly 31 provides a second force for the third body 30 relative to the second body 20. The second force is greater than the first force, which allows the third body 30 and the second body 20 to rotate together relative to the first body 10 through the first connecting assembly 21 in active state. In some embodiments of the present disclosure, the first connecting assembly 21 and the second connecting assembly 31 can be the first rotating shaft and the second rotating shaft, respectively. The first force is the first damping force provided by a corresponding first damping assembly on the first rotating shaft, and the second force is the second damping force provided by a corresponding second damping assembly on the second rotating shaft. As a result, in this embodiment, by setting the first damping force to be less than the second damping force, the first rotating shaft is in the active first state. When the user opens or adjusts the angle of the electronic device, the pushing force applied to the third body 30 is transmitted to both the first and second rotating shafts, and preferentially makes the first rotating shaft rotate. Consequently, the second rotating shaft remains in the inactive second state, and does not rotate in response to the pushing force of the user. As a result, the second body 20 and the third body 30, connected by the second rotating shaft, maintain their relative positional relationship while moving relative to the first body 10 through the rotation of the first rotating shaft.

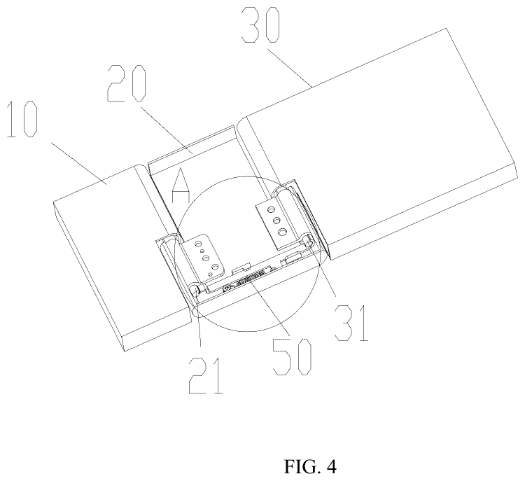

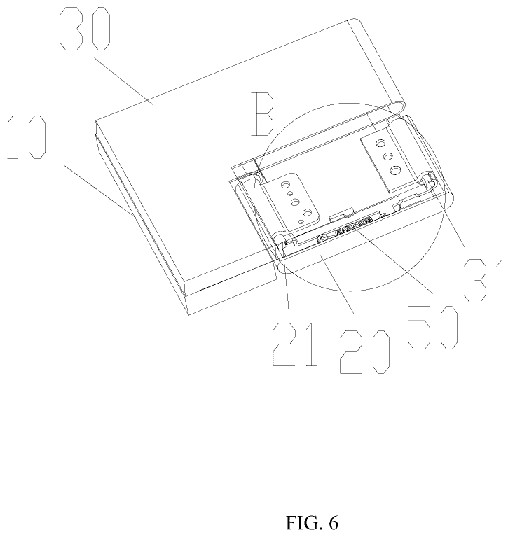

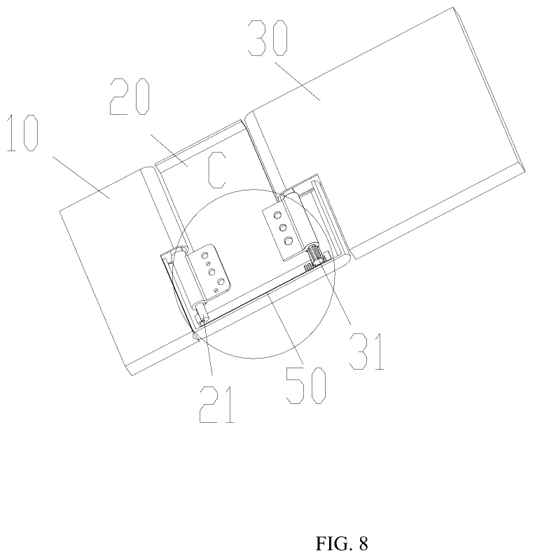

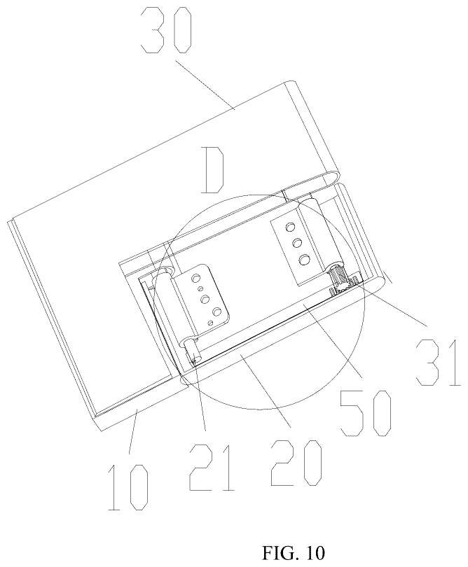

FIG. 4 to FIG. 11 show the diagrams of the electronic device. They further illustrate the different states of the first connecting assembly 21 and the second connecting assembly 31. Additionally, the different implementation structures of an adjustment assembly 50 are shown schematically. In some embodiments, the first connecting assembly 21 and the second connecting assembly 31 are connected via the adjustment assembly 50, which is positioned inside the second body 20. By adjusting the different connection states between the first connecting assembly 21 and the second connecting assembly 31, the adjustment assembly 50 switches the states of the first connecting assembly 21 and the second connecting assembly 31.

In some embodiments of the present disclosure, the first connecting assembly 21 is used to connect the first body 10 and the second body 20, which implements a rotational connection, while the second connecting assembly 31 connects the second body 20 and the third body 30, which also implements a rotational connection. To ensure that there is no twisting angle between the rotation direction of the third body 30 and the second body 20, the rotation axis of the first connecting assembly 21 is parallel to the rotation axis of the second connecting assembly 31. The adjustment assembly 50 is positioned between the first connecting assembly 21 and the second connecting assembly 31, and can interact and connect with both the assembly 21 and the second connecting assembly 31. The adjustment assembly 50 is perpendicular to the rotation axes of the first connecting assembly 21 and the second connecting assembly 31. Moreover, the adjustment assembly 50 can move along with the flipping of the third body 30 relative to the second body 20, which makes it approaching or moving away from the first connecting assembly 21. In other words, the movement direction of the adjustment assembly 50 is perpendicular to the rotation axes of the first connecting assembly 21 and the second connecting assembly 31.

In some specific applications, the adjustment assembly 50 moves in the direction away from the first connecting assembly 21, with its first end moving away from the first connecting assembly 21 until it no longer engages. At this point, the first connecting assembly 21 is in the first state, which means that the adjustment assembly 50 is not engaged with the first connecting assembly 21, which allows the first connecting assembly 21 to remain unaffected by the adjustment assembly 50 and be in an active state. As a result, the first connecting assembly 21 is not locked by the adjustment assembly 50, and can rotate to adjust the angle between the first body 10 and the second body 20. In some specific movements, the second end of the adjustment assembly 50 correspondingly connects to the second connecting assembly 31 for adaptive connection. Through the movement of the second connecting assembly 31, the third body 30 is brought into a flattened state relative to the second body 20. When the rotational travel of the second connecting assembly 31 reaches its maximum angle, the first end of the adjustment assembly 50 moves away from the first connecting assembly 21 and is no longer engaged. At this point, when the first connecting assembly 21 is in the active first state, the second connecting assembly 31 is in the inactive second state. This can be achieved by setting the second force to be greater than the first force. As a result, the flattened relative positional relationship between the second body 20 and the third body 30 will remain unchanged.

In some other specific applications, the adjustment assembly 50 moves in the direction toward the first connecting assembly 21, with its first end approaching the first connecting assembly 21 until the first connecting assembly 21 is stably engaged. At this point, the first connecting assembly 21 is in the second state, which means the adjustment assembly 50 and the first connecting assembly 21 are interlocked, and the first connecting assembly 21, based on this engagement, is in the inactive second state. In some embodiments, the first connecting assembly 21 is locked by the adjustment assembly 50 and cannot rotate or function. As a result, the angle between the first body 10 and the second body 20 cannot be adjusted through the first connecting assembly 21, and their relative positional relationship remains unchanged. To facilitate the subsequent movement of the adjustment assembly 50 driven by the second connecting assembly 31, the second end of the adjustment assembly 50 does not disengage from the second connecting assembly 31, which remains at least partially aligned with the projection of the second connecting assembly 31 along the first direction. In this embodiment, the first direction refers to the direction perpendicular to the first body 10. The projection of the second connecting assembly 31 in the direction perpendicular to the first body 10 completely or partially overlaps with the second end of the adjustment assembly 50, maintaining the adaptive connection between the second connecting assembly 31 and the second end of the adjustment assembly 50, allowing the adjustment assembly 50 to continue moving as driven by the second connecting assembly 31.

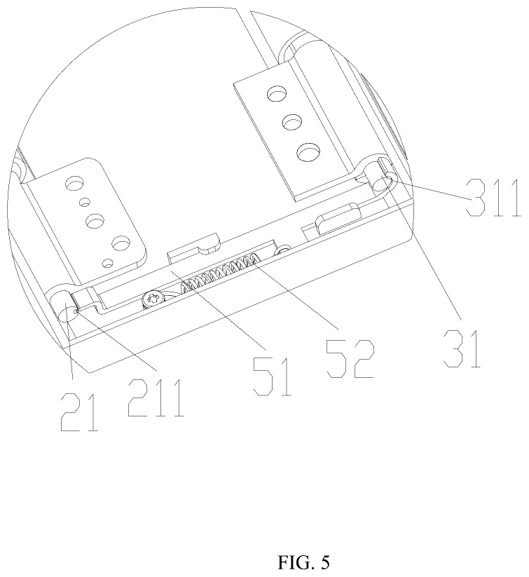

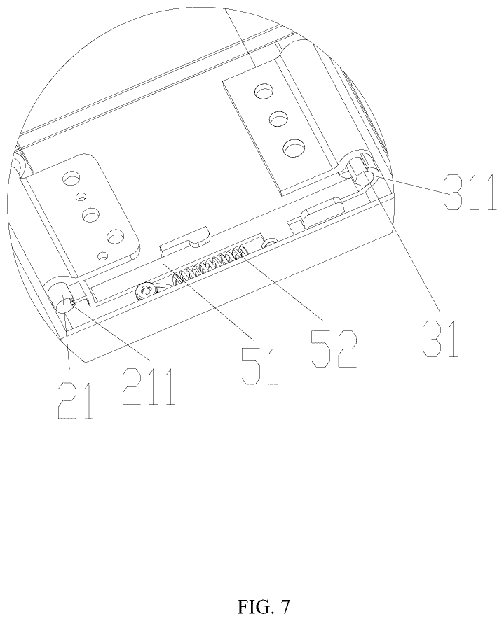

In some embodiments of the present disclosure, as shown in FIG. 5 and FIG. 7, the adjustment assembly 50 includes a linkage 51 and an elastic component 52, which are connected to each other. The middle part of the linkage 51 is connected to the second body 20 through the elastic component 52. Its first end can engage with the first connecting assembly 21, which allows the first connecting assembly 21 to be locked in the inactive second state through this engagement, or disengage from the first connecting assembly 21, so that the first connecting assembly 21 is not locked and remains in the active first state. The second end of the linkage 51 is adapted to connect with the second connecting assembly 31. In this embodiment, when the linkage 51 moves away from the first connecting assembly 21, the elastic component 52 is stretched or compressed, which leads to deformation of the device. This generates an elastic force, which makes the elastic component 52 return to its original shape. When the external force disappears, this elastic force drives the linkage 51 to move relative to the second body 20, and return to its initial position relative to the second body 20.

In some embodiments, when the first end of the linkage 51 is connected to the first connecting assembly 21, which means when the first end of the linkage 51 is engaged with the first connecting assembly 21, the first connecting assembly 21 is locked through this engagement, and remains in the inactive second state. As a result, the relative positional relationship between the first body 10 and the second body 20 remains unchanged, while the second connecting assembly 31 is in the active first state, which allows the third body 30 to move relative to the second body 20. At this point, the electronic device will be in the first operating mode.

When the first end of the linkage 51 is disengaged from the first connecting assembly 21 and they are not engaged, the first connecting assembly 21 is in the active first state, as it is not locked by the engagement. When the second force of the second connecting assembly 31 is greater than the first force of the first connecting assembly 21, and the user applies force to the third body 30, the first connecting assembly 21 rotates first, which causes the second connecting assembly 31 to remain in the inactive second state. As a result, the relative positional relationship between the second body 20 and the third body 30 remains unchanged, and they move as an entire unit relative to the first body 10. At this point, the electronic device is in the second operating mode.

It can be understood that when an external force is applied on the elastic component 52, it generates an elastic force which is able to tightly press the linkage 51 against the second connecting assembly 31, which creates the friction between the linkage 51 and the second connecting assembly 31.

In some embodiments of the present disclosure, when the first connecting assembly 21 is the first rotating shaft and the second connecting assembly 31 as the second rotating shaft, a limiting slot 211 for engagement can be configured on the side of the first rotating shaft facing the linkage 51. One end of the linkage 51 is matched to the limiting slot 211, and can extend into the limiting slot 211 for either engagement or move away from the limiting slot 211 for disengagement. The other end of the linkage 51 may be sleeved on the second rotating shaft. The middle part of the linkage 51 is connected to the second body 20 via the elastic component 52. A protrusion 311 may be formed on the second rotating shaft. When the second rotating shaft rotates in a direction away from the second body 20, the protrusion 311 rotates to a position where it can contact the second end of the linkage 51, pushing the linkage 51 in a direction away from the first body 10, which makes the linkage 51 to disengage from the limiting slot 211. At this point, the first connecting assembly 21 is in the first state. Alternatively, when the second rotating shaft rotates in a direction toward the second body 20, the protrusion 311 moves away from the second end of the linkage 51, and the restoring force of the elastic component 52 drives the linkage 51 in the direction toward the first rotating shaft, which makes the first end of the linkage 51 to engage with the limiting slot 211. At this point, the first connecting assembly 21 is in the second state.

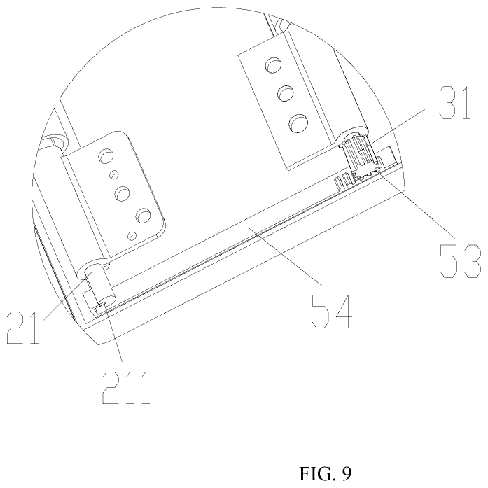

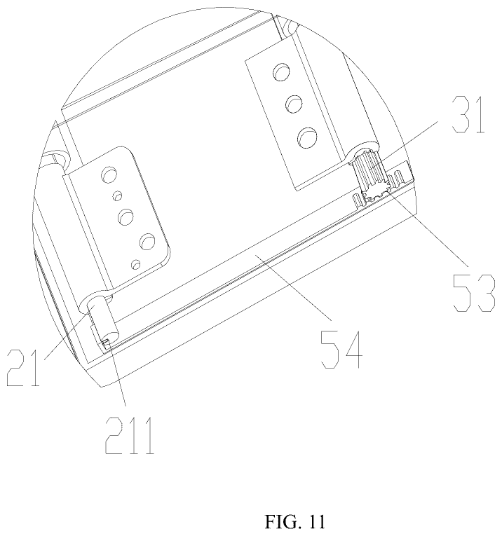

In some embodiments of the present disclosure, as shown in FIG. 9 and FIG. 11, the adjustment assembly 50 includes a transmission wheel 53 and a transmission component 54, which are transmission connected. The transmission wheel 53 is connected to the second connecting assembly 31. The transmission component 54 has a first end and a second end arranged oppositely. The second end of the transmission component 54 is adapted to the transmission wheel 53 to achieve transmission linkage. Through the relative movement of the transmission component 54 and the transmission wheel 53, the first end of the transmission component 54 can either engage with the first connecting assembly 21, which locks the first connecting assembly 21 through engagement, or releases the first connecting assembly 21, which unlocks the first connecting assembly 21 from engagement.

In some embodiments, when the first end of the transmission component 54 is connected with the first connecting assembly 21, specifically, when the first end of the transmission component 54 engages with the first connecting assembly 21, the first connecting assembly 21 is locked by the engagement, and is in the inactive second state. As a result, the relative positional relationship between the first body 10 and the second body 20 remains unchanged, while the second connecting assembly 31 is in the active first state, which allows the third body 30 to move relative to the second body 20. At this point, the electronic device is in the first operating mode.

When the first end of the transmission component 54 is not connected to the first connecting assembly 21, specifically, when the first end of the transmission component 54 disengages from the first connecting assembly 21, while they are not engaged, the first connecting assembly 21 is in the active first state. When the second force of the second connecting assembly 31 is greater than the first force of the first connecting assembly 21, and the user applies force to the third body 30, the first connecting assembly 21 shall rotate first, which makes the second connecting assembly 31 to remain in the inactive second state. As a result, the relative positional relationship between the second body 20 and the third body 30 remains unchanged, and they can move as an entire unit relative to the first body 10. At this point, the electronic device is in the second operating mode.

In this embodiment, the transmission wheel 53 can be a gear, and the transmission component 54 can be a rack that fits with the gear. In an exemplary embodiment, when the first connecting assembly 21 is the first rotating shaft, and the second connecting assembly 31 is the second rotating shaft, the gear can be arranged coaxially with the second rotating shaft and located at the end of the second rotating shaft. On the corresponding position, which is on the first rotating shaft, and on the side facing away from the gear, a limiting slot 211 for engagement can be configured. The first end of the rack matches the limiting slot 211, and can extend into the limiting slot 211 for engagement, connecting with the first connecting assembly 21, which locks the first connecting assembly 21 in the second state by the engagement. Alternatively, the rack can move away from the limiting slot 211, releasing the first connecting assembly 21, which unlocks the first connecting assembly 21 to the first state. The second end of the rack can form a transmission connection with the gear. For example, the gear can be sleeved on one end of the second rotating shaft, and the interaction force between the gear and the second rotating shaft can be set according to actual conditions, so that the gear rotates along with the second rotating shaft, which drives the rack to move. Alternatively, when the rack moves to a pre-defined position, such as into the limiting slot 211 or away from the limiting slot 211 into a pre-defined space within the electronic device opposite the limiting slot, the gear will be constrained by the rack and unable to continue rotating. In some embodiments, the user can apply greater force to allow the second rotating shaft to rotate relative to the gear, which enables the second rotating shaft to continue rotating.

In this embodiment, in some specific applications, when the second rotating shaft rotates in the direction away from the second body 20, the gear pushes the rack toward the first rotating shaft. The first end of the rack moves away from the limiting slot 211 on the side of the first rotating shaft facing away from the gear, disengaging from the first rotating shaft, which makes the first connecting assembly 21 in the first state. Alternatively, when the second rotating shaft rotates in the direction toward the second body 20, the gear pulls the rack in the direction away from the first rotating shaft. The first end of the rack moves toward the side of the first rotating shaft facing away from the gear, engaging with the limiting slot 211, which makes the first connecting assembly 21 in the second state.

In some embodiments of the present disclosure, the display screen 40 includes a first region 41, a second region 42, and a third region 43. The first region 41 is connected to the second body 20, the second region 42 is connected to the third body 30, and the third region 43 is connected to both the first region 41 and the second region 42. In this embodiment, the first body 10 can be the main body of the electronic device, and the display screen 40 includes a flexible screen portion. The portions of the display screen 40 corresponding to the second body 20 and the third body 30 can be the first region 41 and the second region 42 of the electronic device, respectively. The flexible screen portion of the display screen 40 serves as the connecting area between the first region 41 and the second region 42, which is able to bend and accommodate the deformation that forms an angle between the second body 20 and the third body 30. This flexible screen portion can be the third region 43 of the display screen 40.

When the electronic device is in the first operating mode, the second connecting assembly 31 is in the active first state, which allows relative movement between the second body 20 and the third body 30, connected by the second connecting assembly 31. The first region 41 and the second region 42 corresponding to the second body 20 and the third body 30 can form a target angle according to the requirement of the user. The target angle can be set based on the requirement of the user. For example, options of 120° and 135° can be provided for the user to select and use. When the first region 41 and the second region 42 form the target angle, the flexible screen portion between the first region 41 and the second region 42 then bends into deformation, to smoothly transition the connecting area between the first region 41 and the second region 42.

When the electronic device is in the second operating mode, the angle between the second body 20 and the third body 30 is 180°. In some embodiments, the display screen 40 corresponding to the second body 20 and the third body 30 can be in a flattened state, which means that the first region 41 and the second region 42 are in a flattened state, and the third region 43 is stretched flat. This means that the third region 43 is on the same plane as the first region 41 and the second region 42, meeting the condition of being coplanar.

Additionally, although exemplary embodiments have been described herein, the scope includes any and all embodiments that feature equivalent elements, modifications, omissions, combinations (e.g., combinations of various embodiments), adaptations, or alterations based on this application. The elements in the claims shall be interpreted broadly based on the language used in the claims and are not limited to the examples described in this specification or during the implementation of this application, which are intended to be non-exclusive. Therefore, this specification and examples are to be considered exemplary only, with the true scope and spirit being indicated by the following claims and their full range of equivalents.

The above descriptions are intended to be illustrative rather than restrictive. For example, the above examples (or one or more variations thereof) may be used in combination with one another. Those skilled in the art, upon reading the above descriptions, may implement other embodiments. Furthermore, in the above specific embodiments, various features may be grouped together to simplify the disclosure of this application. This shall not be interpreted as an intention to require the unclaimed features as necessary to any of the claims. On the contrary, the subject matter of this application may comprise fewer than all features of the specifically disclosed embodiments. Therefore, the following claims are incorporated into the detailed description as examples or embodiments, with each claim being considered an independent embodiment. These embodiments may be combined or arranged with one another in various combinations. The scope of this application should be determined with reference to the appended claims and the full range of equivalents to which those claims are entitled.

The above detailed descriptions of multiple embodiments of the present application are provided, but the present application is not limited to these specific embodiments. Based on the embodiments of the present disclosure, all other embodiments obtained by those skilled in the art without creative work are within the scope of the present disclosure.

What is claimed is:

1. An electronic device, comprising:
a first body, including an input surface;
a second body, connected to the first body through a first connecting assembly, wherein the first connecting assembly has a first state and a second state different from the first state;
a third body, connected to the second body through a second connecting assembly, wherein the second connecting assembly has a first state, and a second state different from the first state; and
a display screen, connected to both the second body and the third body, wherein the display screen and the input surface are positioned on a same side of the electronic device; wherein:
if the electronic device is in a first operating mode, the first connecting assembly is in the second state, such that the relative position between the first body and the second body remains unchanged, and the second connecting assembly is in the first state;
if the electronic device is in a second operating mode, the first connecting assembly is in the first state and the second connecting assembly is in the second state, such that the relative position between the second body and the third body remains unchanged.

2. The electronic device according to claim 1, wherein, when the electronic device is in the first operating mode and the third body moves relative to the second body to satisfy a first relative positional relationship, the first connecting assembly switches from the second state to the first state, and the second connecting assembly switches from the first state to the second state, allowing the electronic device to switch to the second operating mode, while the third body and the second body satisfy in the first relative positional relationship such that the display screen is in a flattened state.

3. The electronic device according to claim 2, wherein, when the electronic device is in the second operating mode and the second body moves relative to the first body to satisfy a second relative positional relationship, the first connecting assembly switches from the first state to the second state, and the second connecting assembly switches from the second state to the first state, allowing the electronic device to switch to the first operating mode, while the first body and the second body satisfy the second relative positional relationship, such that the first body and the second body both contact a same supporting surface.

4. The electronic device according to claim 2, wherein, when the electronic device is in the second operating mode and a force applied to the second connecting assembly is greater than the frictional force of the second connecting assembly in the second state, the third body moves relative to the second body to satisfy a third relative positional relationship, which makes the second connecting assembly switch from the second state to the first state, and makes the first connecting assembly switch from the first state to the second state, allowing the electronic device to switch to the first operating mode, while the third body and the second body satisfy a third relative positional relationship such that the display screen is in a folded state.

5. The electronic device according to claim 1, wherein the first connecting assembly provides a first force when the second body moves relative to the first body;
the second connecting assembly provides a second force when the third body moves relative to the second body; and
the second force is greater than the first force, allowing the third body and the second body to rotate together relative to the first body via the first connecting assembly in the first state.

6. The electronic device according to claim 1, wherein the first connecting assembly and the second connecting assembly are connected by an adjustment assembly, wherein the adjustment assembly being located inside the second body;
in the first state, the first end of the adjustment assembly is not engaged with the first connecting assembly, and the second end of the adjustment assembly is connected to the second connecting assembly, allowing the second body to remain flattened relative to the third body; and
in the second state, the first end of the adjustment assembly engages with the first connecting assembly to fix the position of the second body relative to the first body, and the second end of the adjustment assembly overlaps at least partially with a projection of the second connecting assembly in the first direction.

7. The electronic device according to claim 6, wherein the rotational axes of the first connecting assembly and the second connecting assembly are parallel to each other; and
the adjustment assembly is perpendicular to the rotational axes.

8. The electronic device according to claim 6, wherein the adjustment assembly comprises a linkage and an elastic component;
the linkage is connected to the second body through the elastic component, and the elastic component is configured to provide an elastic force to the linkage relative to the second body; and
if a first end of the linkage is in the second state relative to the first connecting assembly and a second end of the linkage is connected to the second connecting assembly, the electronic device is in the first operating mode; and
if the first end of the linkage is in the first state relative to the first connecting assembly and the second end of the linkage is connected to the second connecting assembly, the electronic device is in the second operating mode.

9. The electronic device according to claim 7, wherein the adjustment assembly includes a transmission wheel and a transmission component; and
the transmission wheel is connected to the second connecting assembly, and the transmission component has a first end and a second end, with the second end of the transmission component being engaged with the transmission wheel and moving relative to the transmission wheel, causing the first end to be in the first or second state relative to the first connecting assembly; wherein
if the first end of the transmission component is in the second state relative to the first connecting assembly and the second end of the linkage is connected to the second connecting assembly, the electronic device is in the first operating mode; and
if the first end of the transmission component is in the first state relative to the first connecting assembly and the second end of the linkage is connected to the second connecting assembly, the electronic device is in the second operating mode.

10. The electronic device according to claim 1, wherein the display screen comprises a first region, a second region, and a third region, wherein the first region is connected to the second body, the second region is connected to the third body, and the third region is connected to both the first region and the second region; and
if the device is in the first operating mode, the first region and the second region form a target angle, and the third region deforms between the third body and the second body; and
if the device is in the second operating mode, the display screen is in a flattened state, and the third region is coplanar with the first region and the second region.
